(19) United States
(12) Patent Application Publication
(10) Pub. No.: US 2022/0268430 A1
(43) Pub. Date: Aug. 25, 2022

(54) LUMINAIRE STRUCTURE

(71) Applicant: AXIS LIGHTING INC., Lasalle (CA)

(72) Inventors: Theodore PORTER, Lasalle (CA); Andrew MILES, Lasalle (CA); Howard YAPHE, Lasalle (CA)

(21) Appl. No.: 17/185,361

(22) Filed: Feb. 25, 2021

(51) Int. Cl. F21V 23/04; F21S 4/28

(52) U.S. Cl. CPC F21V 23/0471; F21S 4/28

(57) ABSTRACT

Disclosed is a luminaire structure including a housing structure defining at least one light output region that may be at least partially enclosed and/or recessed, and bordered by at least two opposed housing boundary regions. The housing boundary regions define at least one light delivery zone spaced from the light output region, to deliver light to at least one adjacent interior space. At least one first sensor is configured to sense at least one parameter within a sensing field adjacent the at least one first sensor, while a positioning structure is configured to position the at least one first sensor at an operative sensor location at least partially enclosed or recessed, and adjacent the light delivery zone. The operative sensor location and the at least two opposed boundary regions may be configured to present the sensing field to the adjacent interior space without operative obstruction by the at least two opposed boundary regions.

### REFERENCE TO CO-PENDING APPLICATIONS

The disclosures set forth in the following applications are incorporated herein by reference in their entireties:
U.S. application Ser. No. 16/899,047, filed Jun. 11, 2020 entitled LUMINAIRE STRUCTURE;
U.S. application Ser. No. 17/067,369, filed Oct. 9, 2020 entitled LUMINAIRE STRUCTURE;
U.S. application Ser. No. 29/624,853, filed Nov. 3, 2017 entitled LUMINAIRE STRUCTURE; and
U.S. application Ser. No. 29/603,542, filed May 10, 2017 entitled LUMINAIRE STRUCTURE, issued U.S. D905326, issue date Dec. 15, 2020.

### FIELD OF THE DISCLOSURE

The present disclosure relates to luminaire structures and associated structures, for integrating sensors.

### BACKGROUND

Lighting continues to be an important aspect of interior design, and with it, the need to be able to have luminaire structures able to be responsive to changing conditions or events, within an interior space, which may arise by changing ambient light conditions, the arrival to or departure of people from the interior space, or a desired change in interior lighting. Difficulties can sometimes arise by the placement of sensors in order to be operationally sensitive to such changes or events.

It may be desirable to provide novel approaches for luminaire structures, or at least to provide the public with one or more useful alternatives.

### SUMMARY

An aspect may provide a luminaire structure comprising a housing structure defining at least one light output region which is bordered by at least two opposed housing boundary regions. The housing boundary regions may cooperate to define at least one light delivery zone spaced from the light output region, to deliver light to at least one adjacent interior space. At least one first sensor may be configured to sense at least one parameter within a sensing field adjacent the at least one first sensor. Positioning structure may be configured to position the at least one first sensor at an operative sensor location which is at least partially enclosed or recessed, and which is adjacent the light delivery zone. The operative sensor location and the at least two opposed boundary regions may be configured to present the sensing field to the adjacent interior space without operative obstruction by the at least two opposed boundary regions.

In some example embodiments, the at least one light output region may be at least partially enclosed and/or recessed.

In some example embodiments, the at least one light output region may include a direct light output region.

In some example embodiments, the at least one first sensor may be spaced from or adjacent the direct light output region.

In some example embodiments, the sensing field may be configured to form a volume with at least one first included angle, and the at least two opposed boundary regions may include respective boundary surfaces which define at least one second included angle, wherein the operative sensor location and the second designated included angle may be configured to non-obstructively accommodate the designated included angle.

In some example embodiments, the at least two opposed housing boundary regions may extend between a first end region and an opposed second end region, with the at least one first sensor located in the first end region, and may further comprise at least one second sensor located in the second end region.

In some example embodiments, the at least one light output region may include an indirect light output region, and the at least one first sensor may be spaced from or adjacent the indirect light output region.

### BRIEF DESCRIPTION OF THE FIGURES

Several exemplary embodiments of the present disclosure will be provided, by way of examples only, with reference to the appended drawings, wherein:

FIGS. 1 and 2 are a lower perspective view and an upper perspective view, respectively, of a luminaire structure;

FIG. 3 is an upper perspective sectional view of the luminaire structure of FIG. 1 taken along line 3-3 in FIG. 2;

FIGS. 4 and 5 are an end view and a schematic operational end view, respectively, of the luminaire structure of FIG. 1; and

FIG. 6 is a bottom plan view of the luminaire structure of FIG. 1.

### DETAILED DESCRIPTION

It should be understood that the invention is not limited in its application to the details of construction and the arrangement of components set forth in the following description or illustrated in the drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical, mechanical or other connections or couplings. The terms upper, lower, and vertical are intended for operative context only and are not necessarily intended to limit the invention only to those configurations or orientations. In any instance in which the disclosure refers to a single instance of an element, example embodiments may include a multiple of such elements. The term “at least one” in reference to any element is not intended to force an interpretation on any other reference elsewhere in the disclosure to a single instance of an element to mean only one such instance of the element. Furthermore, and as described in subsequent paragraphs, the specific mechanical and/or other configurations illustrated in the drawings are intended to exemplify embodiments of the invention. However, other alternative mechanical and/or other configurations are possible which are considered to be within the teachings of the instant disclosure. Furthermore, any one element, feature, structure, function, of any aspect and/or example embodiment described in the present disclosure including the figures, clauses and/or claims herein, may itself be claimed on its own or be combined with any one or more elements, features, structures, functions, and/or steps from the same or any other aspects and/or example embodiments described in the present disclosure including the figures, clauses and/and claims herein.

The term “LED” used herein may include, but not be limited to, semiconductor, electroluminescent, organic, polymeric or other material based light sources commonly known as generally as light emitting diodes, as well as polymeric and other such light sources, equivalents and variants thereof.

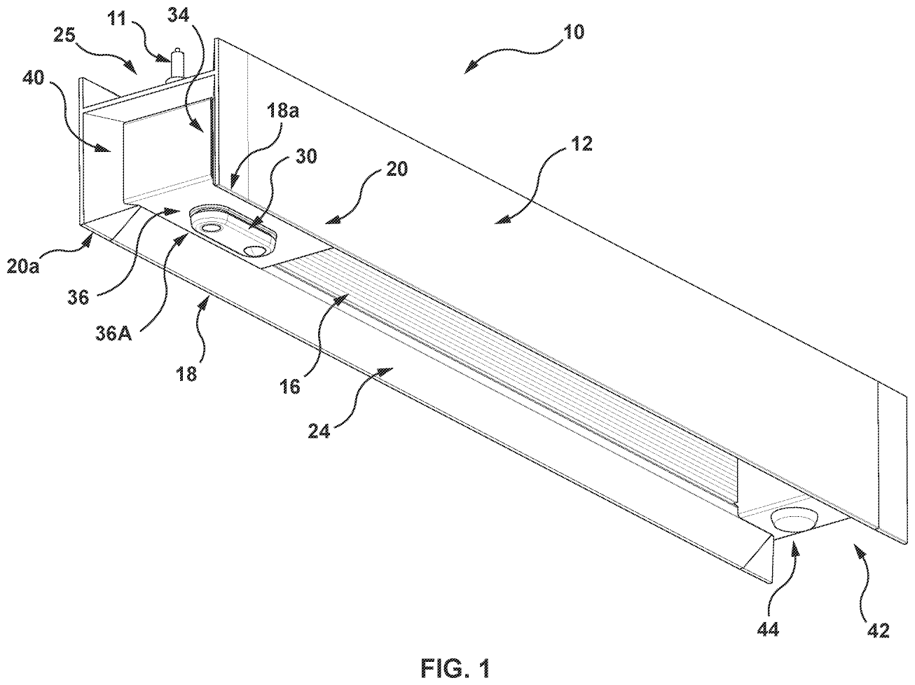

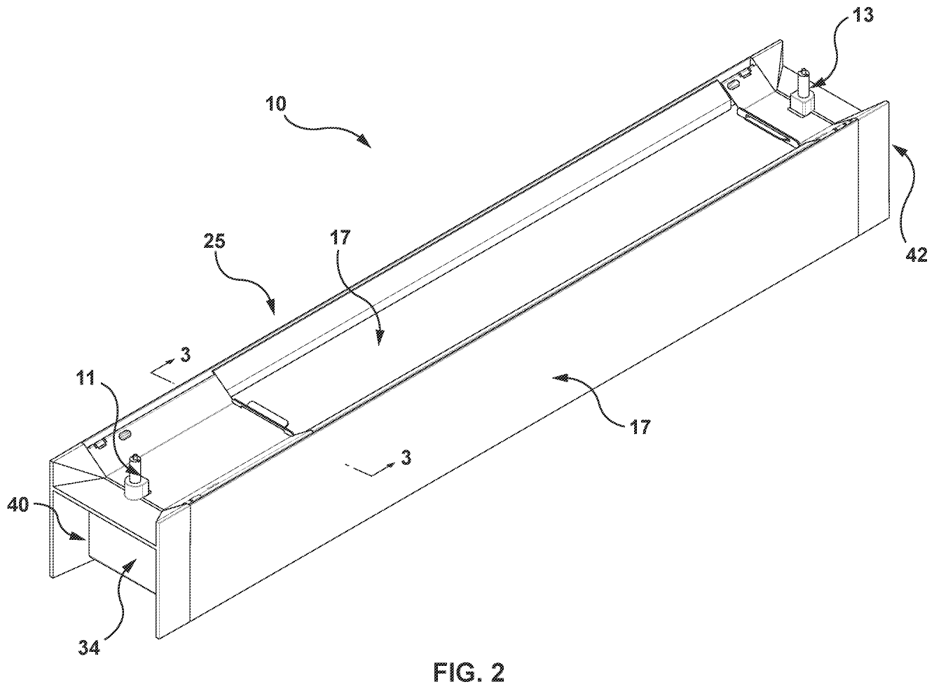

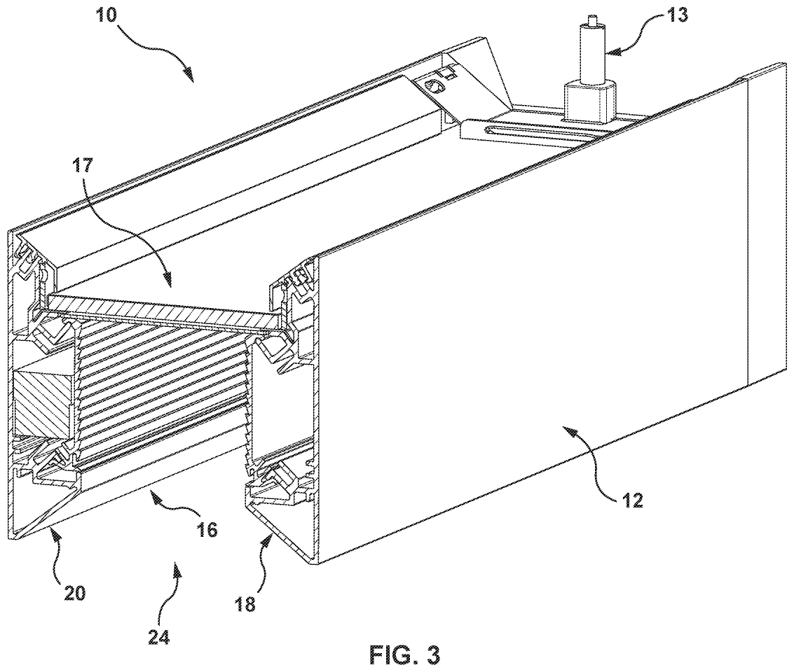

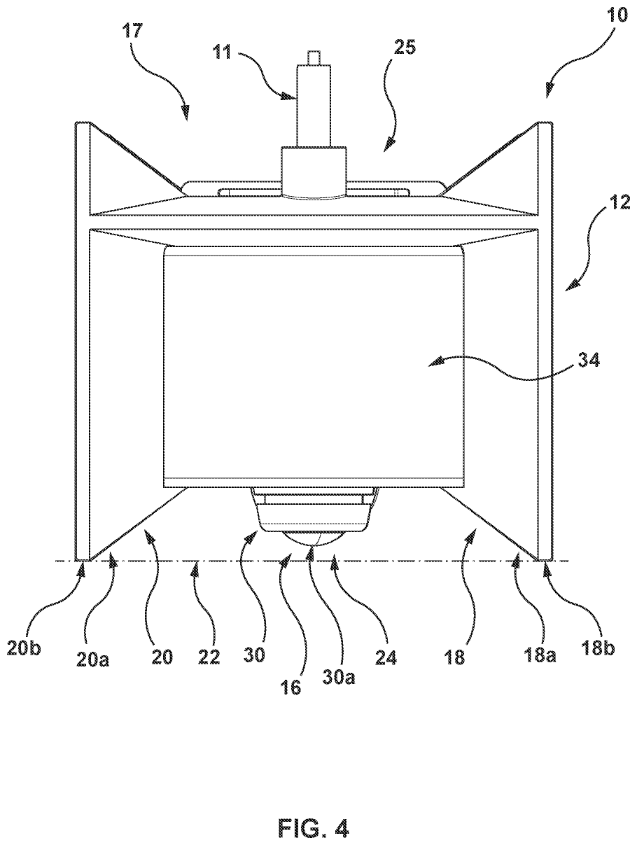

Referring to figures, particularly FIGS. 1 and 4, there is provided a luminaire structure 10, which may be seen to be a linear luminaire structure, comprising a housing structure 12, in this case may be an elongate housing structure, defining at least one light output region, which in this case may be an elongate direct (or downlight) output region 16 and/or an elongate indirect light output region 17. The luminaire structure 10 can be suspended by structures 11, 13. These supports can be cable-type structures, rigid structures, or any other suitable structures to support the luminaire structure 10 housing 12 and related components. The structures can also provide a path for power and control lines to and from the luminaire 10. One or both of the light output regions 16 and 17 may be at least partially enclosed or recessed and, in this case, also bordered by at least two opposed housing boundary regions 18, 20, which may cooperate to define at least one light delivery zone, in this case lower and upper light delivery zones 24, 25 as shown in FIG. 4, which may be spaced from the light output regions 16 and 17, to deliver light to at least one adjacent interior space as shown at 26.

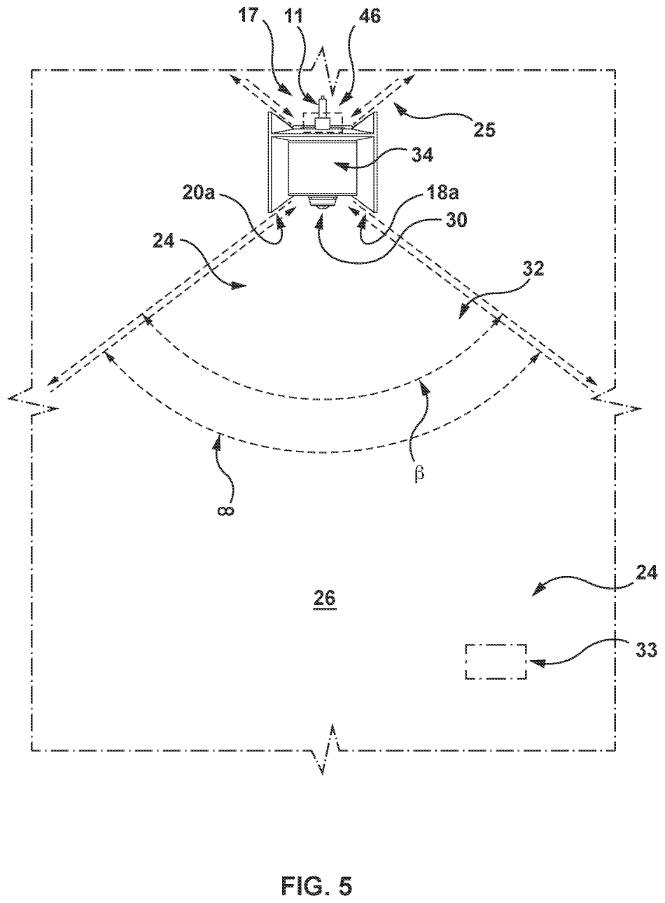

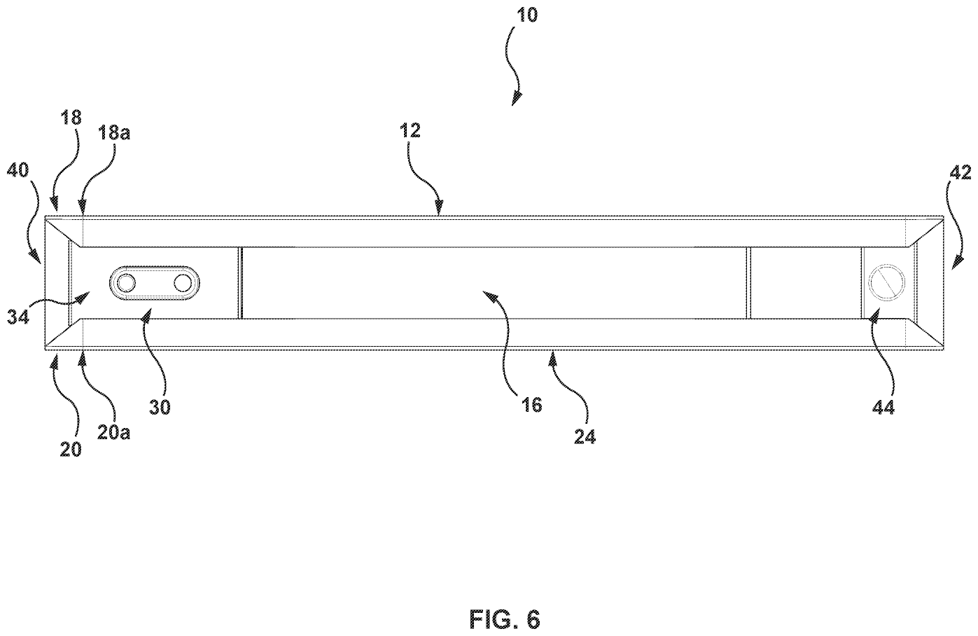

Referring to FIGS. 4 and 5, at least one first sensor 30 may be positioned adjacent the lower light delivery zone 24 and may be configured to sense at least one parameter within a sensing field 32 adjacent the sensor 30. In this case, the sensor 30 may also receive wireless signals in the sensing field 32, carrying instructional or operational data from a remote controller or other wireless transmitter, shown schematically at 33. Referring to FIG. 1, positioning structure 34 may be provided to position the first sensor 30 to be at an operative sensor location 36 which is at least partially enclosed or recessed, and which is adjacent the light delivery zone 24. In this instance, the positioning structure 34 may include a panel 36A extending across the direct output region 16. The operative sensor location 36 and the at least two opposed boundary regions 18, 20 may be configured to present the sensing field 32 to the adjacent interior space 26 without operative obstruction by the at least two opposed boundary regions 18, 20. In this case, the first sensor 30 may be spaced from the direct output region 16.

The sensor 30 may be provided in a number of forms, such as those for example available from LUTRON among others. The sensing field 32 may be configured to form a volume with at least one first included angle (or beam angle) co, and the at least two opposed boundary regions 18, 20 may include respective boundary surfaces 18a, 20a which define at least one second included angle β, wherein the operative sensor location 36 and the second designated included angle β may be configured to non-obstructively accommodate (for example by being equal to or greater than the designated first included angle ∞, to non-obstructively accommodate the sensing field 32. Thus, the first sensor 30 and for that matter, the respective boundary surfaces 18a, 20a may be chosen and/or configured with a first having regard to the first and second included angles ∞ and β so as to optimize the reception of the signals.

Referring to FIG. 1 the at least two opposed housing boundary regions 18, 20 may be configured to extend between a first end region 40 and an opposed second end region 42, with the at least one first sensor 30 located in the first end region 40, and which may further comprise at least one second sensor 44 located either in the first end region 40, or in the second end region 42, with the second sensor 44 able to be chosen and/configured in a similar matter as with the first sensor 30. In some example embodiments, as shown schematically in FIG. 5, one or more sensors shown schematically at 46 may also be located in the first and/or second end regions 40, 42 and adjacent the upper light delivery zone 25 of the indirect light output region 17.

Thus, in some example embodiments the first and/or second sensors 30, 44 may be shielded, while having an included beam angle that may be maintained so that parameters relevant to the internal space 26 may be monitored, such as movement of occupants in the internal space 26. In this case, the beam angle ∞ may maintained because of the angles (or slopes) of surfaces 18a, 20a of the respective housing boundary regions 18, 20. This, for example, may not otherwise be possible were the angles such that the second included angle β were smaller than the beam angle ∞ and thus would extend into the sensing field. In this case, the sensing field 32 of the sensor 30 may be restricted in such a manner as to unable to sense or detect at least one parameter of the interior space, such as the presence of a person in the interior space not sensed but nonetheless present in the interior space beyond the restricted beam angle. This obstructing effect may in some cases be particularly relevant with linear fixtures with elongate housing structures, having width or lateral dimensions which may be significantly smaller than a length or longitudinal dimension.

Thus, some example embodiments may provide one or more configurations in which at least one partially enclosed or recessed sensor with a designated viewing or beam angle, such as a circular viewing or beam angle, may provide an equivalent viewing or beam angle where, for example, the sensor may otherwise be located on an outer surface so as not to be at least partially enclosed or recessed. Further, the example configuration of the second included angle (such as second included angle β) being equal to or exceeding the first viewing or beam angle (such as the beam angle ∞), may thus enable the sensor to be at least partially enclosed or recessed, to enable the sensor to maintain wireless communications in the sensing field, and enables the sensor to be at least partially or possibly fully hidden from sight to the person and thus not noticed by the person unless the person is directly beneath the luminaire structure.

While the present disclosure describes various exemplary embodiments, the disclosure is not so limited. To the contrary, the disclosure is intended to cover various modifications and equivalent arrangements, as will be readily appreciated by the person of ordinary skill in the art.

1. A luminaire structure comprising a housing structure defining at least one light output region, and which is bordered by at least two opposed housing boundary regions with respective first outermost termini which define a plane therebetween and extending across the at least one light output region, the housing boundary regions cooperating to define at least one light delivery zone spaced from the light output region, to deliver light to at least one adjacent interior space, at least one first sensor having a second outermost terminus and configured to sense at least one parameter within a sensing field adjacent the at least one first sensor and defined by the opposed housing boundary regions, positioning structure configured to position the at least one first sensor at an operative sensor location which is at least partially enclosed or recessed with the second outermost terminus located interior relative to the plane, and which is adjacent the light delivery zone, wherein the operative sensor location and the at least two opposed boundary regions are configured to present the sensing field to the adjacent interior space without operative obstruction by the at least two opposed boundary regions.

2. The luminaire structure of claim 1, wherein the at least one light output region is at least one of partially enclosed and recessed.

3. The luminaire structure of claim 2, wherein the at least one light output region includes a direct light output region.

4. The luminaire structure of claim 3, wherein the at least one first sensor is spaced from or adjacent the direct light output region.

5. The luminaire structure of claim 4, wherein the sensing field is configured to form a volume with at least one first included angle, and the at least two opposed boundary regions include respective planar boundary surfaces which define at least one second included angle, wherein the operative sensor location and the second designated included angle are configured to non-obstructively accommodate the designated included angle.

6. The luminaire structure of claim 5, wherein the at least two opposed housing boundary regions extend between a first end region and an opposed second end region, with the at least one first sensor located in the first end region, and further comprising at least one second sensor located in the second end region.

7. The luminaire structure of claim 5, wherein the at least one light output region includes an indirect light output region, and the at least one first sensor is spaced from or adjacent the indirect light output region.
